(19) United States
(12) Patent Application Publication
(10) Pub. No.: US 2017/0017659 A1
(43) Pub. Date: Jan. 19, 2017

(54) METHODS FOR IDENTIFYING LEVELS OF CONCENTRATED SOCIAL ACTIVITY AT STORED VENUE LOCATIONS WITHIN A REGION AND DEVICES THEREOF

(71) Applicant: Lane Petrauskas, Santa Monica, CA (US)

(72) Inventor: Lane Petrauskas, Santa Monica, CA (US)

(21) Appl. No.: 14/800,182

(22) Filed: Jul. 15, 2015

(51) Int. Cl. G06F 17/30; G06F 3/0484; G06F 3/0482

(52) U.S. Cl. CPC G06F 17/30061; G06F 17/30554; G06F 17/30398; G06F 3/0482; G06F 17/30867; G06F 3/0484

(57) ABSTRACT

Methods, non-transitory computer readable media and devices that identify in real time levels of concentrated social activity at stored venue locations include identifying a location of a client computing device in response to a request for identification of concentrated social activity from the client computing device. A level of social activity at each of the stored venue locations within a first set distance of the identified location is determined based on social media content on one or more social media server devices indexed in real time to each of the stored venue locations within a first set distance of the identified location. At least one social activity interface is generated based on the determined level of social activity at each of the stored venue locations within the first set distance of the identified location. The generated social activity interface is provided to the requesting client computing device.

### FIELD

This technology relates to methods, non-transitory computer readable media and devices for identifying from social media content and in real time levels of concentrated social activity at stored venue locations within a set distance of an identified location.

### BACKGROUND

The amount and types of diverse content, such as text and images, which is input and available in social media websites over the internet through user computing devices continues to grow at outstanding rates. Operators of these user computing devices often may have access to one or more of these social media websites. Unfortunately, there currently is an issue with the ability of existing software technology to be able to effectively access and analyze this social media content data from these diverse social media sources related to social activity and related venues in any meaningful manner.

### SUMMARY

Methods, non-transitory computer readable media and devices that identify in real time levels of concentrated social activity at stored venue locations include identifying, by a social activity analysis computing device, a location of a client computing device in response to a request for identification of concentrated social activity from the client computing device. A level of social activity at each of the stored venue locations within a first set distance of the identified location is determined, by the social activity analysis computing device, based on social media content on one or more social media server devices indexed in real time to each of the stored venue locations within a first set distance of the identified location. At least one social activity interface is generated, by the social activity analysis computing device, based on the determined level of social activity at each of the stored venue locations within the first set distance of the identified location. The generated social activity interface is provided, by the social activity analysis computing device, to the requesting client computing device.

A social activity analysis computing device includes at least one of configurable hardware logic configured to be capable of implementing or a memory coupled to the processor which is configured to be capable of executing programmed instructions stored in the memory to and that comprises identifying a location of a client computing device in response to a request for identification of concentrated social activity from the client computing device. A level of social activity at each of the stored venue locations within a first set distance of the identified location is determined based on social media content on one or more social media server devices indexed in real time to each of the stored venue locations within a first set distance of the identified location. At least one social activity interface is generated based on the determined level of social activity at each of the stored venue locations within the first set distance of the identified location. The generated social activity interface is provided to the requesting client computing device.

A non-transitory computer readable medium having stored thereon instructions for identifying in real time levels of concentrated social activity at stored venue locations comprising machine executable code which when executed by a processor, causes the processor to perform steps includes identifying a location of a client computing device in response to a request for identification of concentrated social activity from the client computing device. A level of social activity at each of the stored venue locations within a first set distance of the identified location is determined based on social media content on one or more social media server devices indexed in real time to each of the stored venue locations within a first set distance of the identified location. At least one social activity interface is generated based on the determined level of social activity at each of the stored venue locations within the first set distance of the identified location. The generated social activity interface is provided to the requesting client computing device.

This technology provides a number of advantages including providing methods, non-transitory computer readable media, and devices that identify from social media content and in real time levels of concentrated social activity at stored venue locations within a set distance of an identified location. With this technology social hotspots at different stored venue locations within a set distance of an identified location or a region can be identified through a real time analysis of social media content from diverse social media sources and then provided to a client computing device in unique and informative formats. Additionally, this technology is able to generate interactive interfaces which enable client computing devices to obtain, interact, and/or filter in real time with the social media content in a region or associated with a selected stored venue location.

### BRIEF DESCRIPTION OF THE DRAWINGS

FIG. 1 is block diagram of an example of a network environment with an social activity analysis management computing device;

FIG. 2 is a block diagram of an example of the social activity analysis computing device illustrated in FIG. 1;

FIG. 3 is a flowchart of an example of a method for identifying from social media content in real time levels of concentrated social activity at stored venue locations within a set distance of an identified location or region;

FIG. 4 is a screenshot of an example of an input interface for entering one or more parameters to index the social media content to stored venue locations within a set distance of an identified location or region;

FIG. 5 is a screenshot of an example of a map view interface;

FIG. 6 is a screenshot of an example of a list view interface;

FIG. 7 is a screenshot of an example of a social content feed interface; and

FIG. 8 is a screenshot of an example of a venue interface.

### DETAILED DESCRIPTION

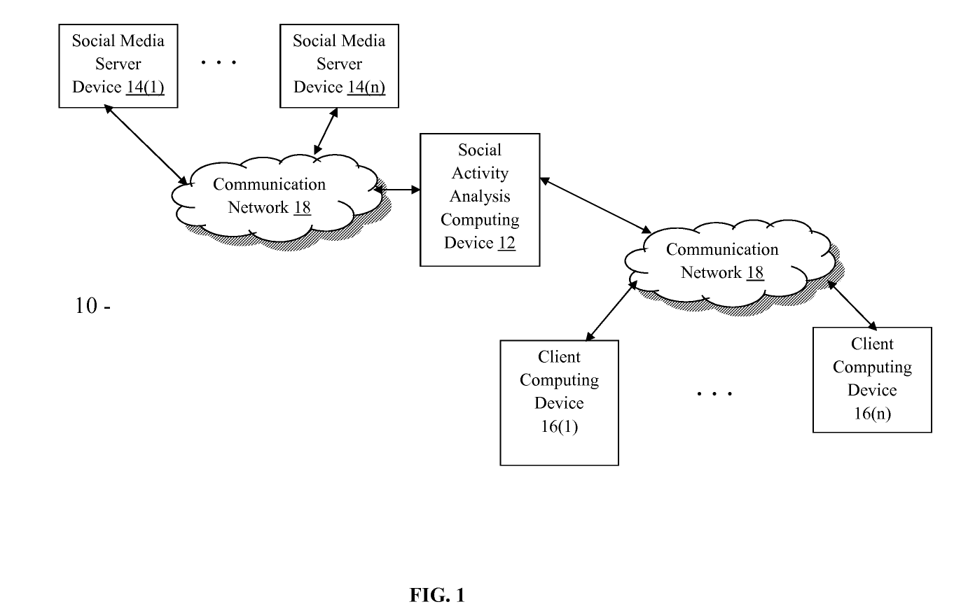

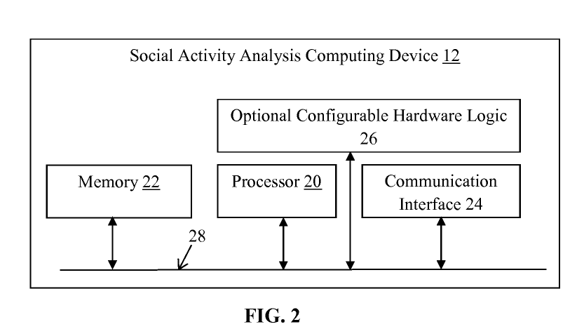

An example of a network environment 10 with a social activity analysis computing device 12 is illustrated in FIGS. 1-2. In this example the environment 10 includes the social activity analysis computing device 12, a plurality of social media server devices 14(1)-14(n), and a plurality of client computing devices 16(1)-16(n) coupled together by one or more communication networks 18 is illustrated in FIGS. 1-2, although this environment 10 can include other types and numbers of systems, devices, components, and/or elements in other configurations. This technology provides a number of advantages including providing more effective methods, non-transitory computer readable medium, and devices that identify from social media content and in real time levels of concentrated social activity at stored venue locations within a set distance of an identified location.

The social activity analysis computing device 12 may perform a number of different types of functions, including by way of example only identifying from social media content in real time levels of concentrated social activity at stored venue locations within a set distance of an identified location or region, although other types and/or numbers of other functions and/or operations may be performed. The social activity analysis computing device 12 in this example includes a processor 20, a memory 22, a communication interface 24, and optional configurable hardware logic 26, which are coupled together by a bus 28 or other link, although other numbers and types of systems, devices, components, and elements in other configurations and locations can be used. The processor 20 in the social activity analysis computing device 12 may execute a program of stored instructions for one or more aspects of the present technology as described and illustrated by way of the examples herein, although other types and numbers of processing devices and logic could be used and the processor 20 could execute other numbers and types of programmed instructions.

The memory 22 in the social activity analysis computing device 12 may store these programmed instructions for one or more aspects of the present technology as described and illustrated herein, although some or all of the programmed instructions could be stored and/or executed elsewhere. A variety of different types of memory storage devices, such as a random access memory (RAM) and/or read only memory (ROM) in the social activity analysis computing device 12 or a floppy disk, hard disk, CD ROM, DVD ROM, or other computer readable medium which is read from and written to by a magnetic, optical, or other reading and writing system that is coupled to the processor 20 in the social activity analysis computing device 12, can be used for the memory 22.

The communication interface 24 of the social activity analysis computing device 12 operatively couples and facilitates communication with one or more of the plurality of social media server devices 14(1)-14(n) and/or the client computing devices 16(1)-16(n) via one or more of the communications networks 18, although other types and numbers of communication networks 18 or systems with other types and numbers of connections and configurations can be used. By way of example only, the one or more communication networks 18 may use TCP/IP over Ethernet and industry-standard protocols, including NFS, CIFS, SOAP, XML, LDAP, and/or SNMP, although other types and numbers of communication networks 18, such as a direct connection, a local area network, a wide area network, each having their own communications protocols, can be used.

The optional configurable hardware logic 26 of the social activity analysis computing device 12 may comprise specialized hardware configured to be capable of implementing one or more steps of this technology as illustrated and described with reference to the examples herein. By way of example only, the optional configurable logic 26 may comprise one or more of field programmable gate arrays (FPGAs), field programmable logic devices (FPLDs), application specific integrated circuits (ASICs) and/or programmable logic units (PLUs).

In this particular example, each of the plurality of social media server devices 14(1)-14(n) may include a processor, a memory, and a communication interface which are coupled together by a bus or other link, although each of the plurality of social media server devices 14(1)-14(n) could other numbers and types of systems, devices, components, and elements in other configurations. The processor in each of the plurality of social media server devices 14(1)-14(n) may execute a program of stored instructions for one or more aspects of the present technology as described and illustrated by way of the examples herein, although other types and numbers of processing devices and logic could be used and the processor could execute other numbers and types of programmed instructions.

The memory in each of the plurality of social media server devices 14(1)-14(n) may store these programmed instructions for one or more aspects of the present technology as described and illustrated herein, although some or all of the programmed instructions could be stored and/or executed elsewhere. A variety of different types of memory storage devices, such as a random access memory (RAM) and/or read only memory (ROM) or a floppy disk, hard disk, CD ROM, DVD ROM, or other computer readable medium which is read from and written to by a magnetic, optical, or other reading and writing system that is coupled to the processor in each of the plurality of client computing devices 16(1)-16(n), can be used for the memory.

The communication interface in each of the plurality of social media server devices 14(1)-14(n) operatively couples and facilitates communication with the social activity analysis computing device 12 and/or the plurality of client computing devices 16(1)-16(n) via one or more of the communications networks 18, although other types and numbers of communication networks or systems with other types and numbers of connections and configurations can be used. By way of example only, the one or more communication networks 18 may use TCP/IP over Ethernet and industry-standard protocols, including NFS, CIFS, SOAP, XML, LDAP, and/or SNMP, although other types and numbers of communication networks 18, such as a direct connection, a local area network, a wide area network, each having their own communications protocols, can be used.

In this particular example, each of the client computing devices 16(1)-16(n) may include a processor, a memory, and a communication interface which are coupled together by a bus or other link, although each of the plurality of client computing devices 16(1)-16(n) could other numbers and types of systems, devices, components, and elements in other configurations. The processor in each of the plurality of client computing devices 16(1)-16(n) may execute a program of stored instructions for one or more aspects of the present technology as described and illustrated by way of the examples herein, although other types and numbers of processing devices and logic could be used and the processor could execute other numbers and types of programmed instructions.

The memory in each of the plurality of client computing devices 16(1)-16(n) may store these programmed instructions for one or more aspects of the present technology as described and illustrated herein, although some or all of the programmed instructions could be stored and/or executed elsewhere. A variety of different types of memory storage devices, such as a random access memory (RAM) and/or read only memory (ROM) or a floppy disk, hard disk, CD ROM, DVD ROM, or other computer readable medium which is read from and written to by a magnetic, optical, or other reading and writing system that is coupled to the processor in each of the plurality of client computing devices 16(1)-16(n), can be used for the memory.

The communication interface in each of the plurality of client computing devices 16(1)-16(n) operatively couples and facilitates communication with the social activity analysis computing device 12 and/or the plurality of social media server devices 14(1)-14(n) via one or more of the communications networks, although other types and numbers of communication networks or systems with other types and numbers of connections and configurations can be used. By way of example only, the one or more communication networks 18 may use TCP/IP over Ethernet and industry-standard protocols, including NFS, CIFS, SOAP, XML, LDAP, and/or SNMP, although other types and numbers of communication networks 18, such as a direct connection, a local area network, a wide area network, each having their own communications protocols, can be used.

Although examples of the social activity analysis computing device 12, the plurality of social media server devices 14(1)-14(n), and the client computing devices 16(1)-16(n) are described herein, it is to be understood that the devices and systems of the examples described herein are for exemplary purposes, as many variations of the specific hardware and software used to implement the examples are possible, as will be appreciated by those skilled in the relevant art(s). In addition, two or more computing systems or devices can be substituted for any one of the systems in any embodiment of the examples

The examples may also be embodied as a non-transitory computer readable medium having instructions stored thereon for one or more aspects of the present technology as described and illustrated by way of the examples herein, as described herein, which when executed by a processor, cause the processor to carry out the steps necessary to implement the methods of the examples, as described and illustrated herein.

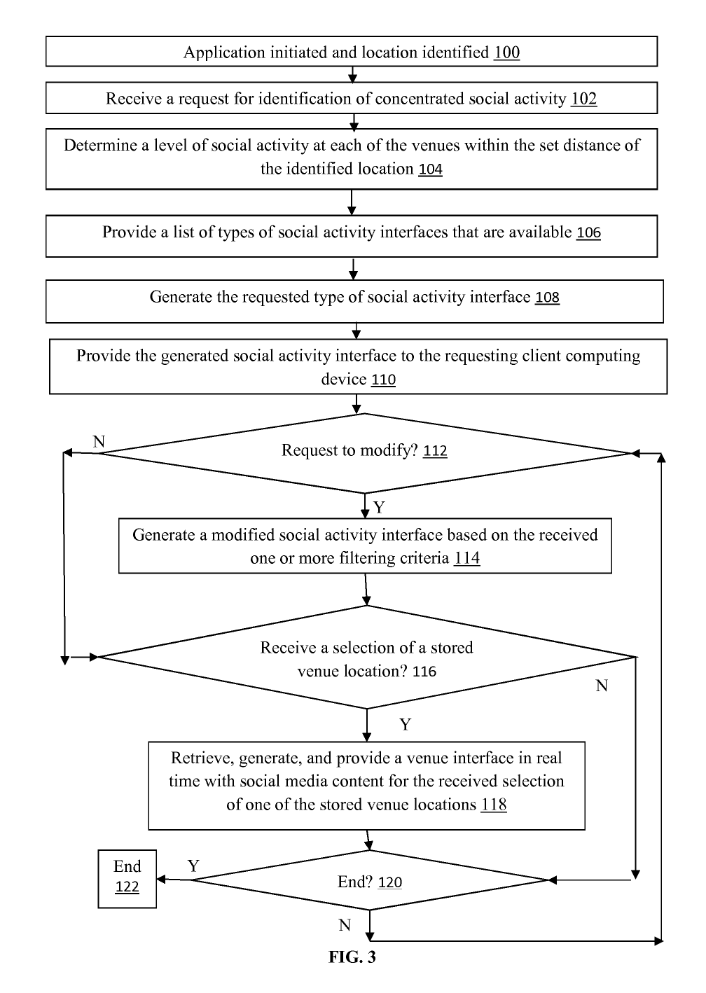

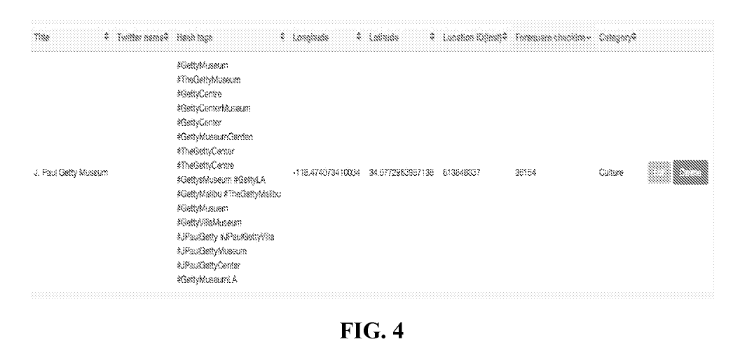

An example of a method for identifying from social media content in real time levels of concentrated social activity at stored venue locations within a set distance of an identified location or a region with the social activity analysis computing device 12 will now be described with reference to FIGS. 1-4. Referring more specifically to FIG. 4, in this example in step 100 one of the client computing devices 16(1)-16(n) may initiate a downloaded application that assists in identifying from social media content in real time levels of concentrated social activity at stored venue locations within a set distance of an identified location or region, although other manners for initiating this technology, such as without a downloaded application and by accessing a designated website may also be used by way of example only. When this application is initiated by the one of the client computing devices 16(1)-16(n), the location of the requesting one of the client computing devices may automatically be provided to the social activity analysis computing device 12, although other manners for identifying or otherwise obtaining a location may be used.

In step 102, the social activity analysis computing device 12 may receive a request for the identification of concentrated social activity from the requesting one of the client computing devices 16(1)-16(n) that initiated the application, although other manners for starting the identification of concentrated social activity. In this particular example, when this request for the identification of concentrated social activity is received, the social activity analysis computing device 12 may use the identified location of the requesting one of the client computing devices 16(1)-16(n) and a stored default value from memory 22 for the set distance which may vary based on the particular identified location, although other types of identified locations and/or set distances could be used. By way of example only, the identified location could by a received input of a selected location from the requesting one of the client computing devices 16(1)-16(n), although other manners for obtaining the identified location could be used. Additionally and by way of example only, the stored set distance for stored venue locations could be different, such as having the set distance for an identified city location could be shorter than the stored set distance for an identified suburban location, although other manners for obtaining the set distance may be used, such as a received input of the set distance from the requesting one of the client computing devices 16(1)-16(n). Further and by way of example only the social activity analysis computing device 12 may retrieve from memory 22 a list of one or more stored venue locations within the set distance, although other manners for identifying the venue locations could be used, such as conducting a real time search of one or more other server computing devices to identify venue locations within the set distance based on one or more factors, such as one or more types of venue locations.

In step 104, the social activity analysis computing device 12 may determine a level or rating of social activity at each of the stored venue locations within the set distance of the identified location based on social media content on one or more social media server devices 16(1)-16(n). In this particular example, the social activity analysis computing device 12 web crawls to index the social media content on one or more social media server devices 16(1)-16(n) in real time to each of the stored venue locations within the set distance of the identified location or the region for a set prior period of time and based on one or more parameters stored in memory 22 and then assigns and tabulates points based on the level of social activity indicated by the retrieved social content data, although other manners for analyzing the current social media content to determine a level of concentrated social activity could be used.

Additionally, in this particular example the social activity analysis computing device 12 may optionally apply one or more weighting factor to the indexed social media content that has been identified to originate from within first stored coordinates or another perimeter in memory 22 for each of the stored venue locations, although other types and/or numbers of adjustments to determining the level of social activity could be applied. By way of example, indexed social media content identified to originate from within first stored coordinate may be given higher weight because of the proximity to the stored venue location

By way of example only, the social activity analysis computing device 12 may determine a level or rating of social activity at each of the stored venue locations based on programmed instructions for an algorithm which calculate a level of social activity and apply different weights is described in greater detail below. In this example, a level or rating of social activity is calculated by the social activity analysis computing device 12 based on social content about each of the stored venue locations retrieved and analyzed from Instagram, Twitter and/or Foursquare which in this example are hosted on the one or more social media server devices 16(1)-16(n), although again, other types and/or numbers of social media websites may be utilized. In this example, the algorithm considers the last six (6) hours of the following types of social activity, although other time periods and/or types of activities could be used with different assigned points.

Instagram: Each post of social content created at one of the stored venue locations, identified by the social activity analysis computing device 12, by way of example by the (location_id). Location_id(s), from posts obtained from one or more of the social media server devices 16(1)-16(n) associated with Instagram adds one (1) point to a level or rating score for the stored venue location. Additionally, each post within a 100 m radius, although other distances could be used, around a stored venue location and which use a stored hashtag associated with the stored venue location identified by the social activity analysis computing device 12 from posts obtained from one or more of the social media server devices 16(1)-16(n) associated with Instagram adds a 0.25 point to a level or rating score for the stored venue location. Further, each post within a 100 m radius, although again other distances could be used, and which does not use any of the one or more stored hashtags associated with the stored venue location identified by the social activity analysis computing device 12 from posts obtained from one or more of the social media server devices 16(1)-16(n) associated with Instagram adds a 0.01 point to a level or rating score for the stored venue location.

Twitter: Each tweet within a 30 meter radius of one of the stored venue locations, although other distances could be used, and which use one or more stored hashtags associated with the stored venue location identified by the social activity analysis computing device 12 from tweets from one or more of the social media server devices 16(1)-16(n) associated with Twitter adds one (1) point to a level or rating score for the stored venue location. Additionally, each tweet within a 30 meter radius of one of the stored venue locations which includes the twitter name associated with the stored venue location identified by the social activity analysis computing device 12 from tweets obtained from the one or more of the social media server devices 16(1)-16(n) associated with Twitter adds 0.8 points to a level or rating score for the stored venue location. Further, each tweet within a 30 meter radius of one of the stored venue locations, although other distances could be used, which does not include the twitter name associated with the stored venue location or use one or more stored hashtags and is identified by the social activity analysis computing device 12 from tweets obtained from the one or more of the social media server devices 16(1)-16(n) associated with Twitter adds 0.1 points to a level or rating score for the stored venue location. Even further, each tweet outside a 30 meter radius of one of the stored venue locations, although other distance can be used, and which use one or more stored hashtags associated with the stored venue location identified by the social activity analysis computing device 12 from tweets obtained from one or more of the social media server devices 16(1)-16(n) associated with Twitter adds 0.01 points to a level or rating score for the stored venue location.

Foursquare: Each check-in at one of the stored venue locations identified by the social activity analysis computing device 12 from obtained social content from one or more of the social media server devices 16(1)-16(n) associated with Foursquare adds one (1) point to a level or rating score for the stored venue location.

A variety of different types and/or numbers of parameters may be used, such as one or more hash tags and one or more handles, stored in memory 22 and associated with one or more of the stored venue locations in memory 22, although other parameters may be used. Additionally, as illustrated in FIG. 4 the social activity analysis computing device 12 may receive a direct input via a user input device coupled to the social activity analysis computing device 12 or an input from an administrator computing device (not shown) coupled to the social activity analysis computing device 12 by way of example only of the one or more parameters associated with one or more of the stored venue locations. Additionally, other manners for obtaining the parameters associated with each of the stored venue locations can be used.

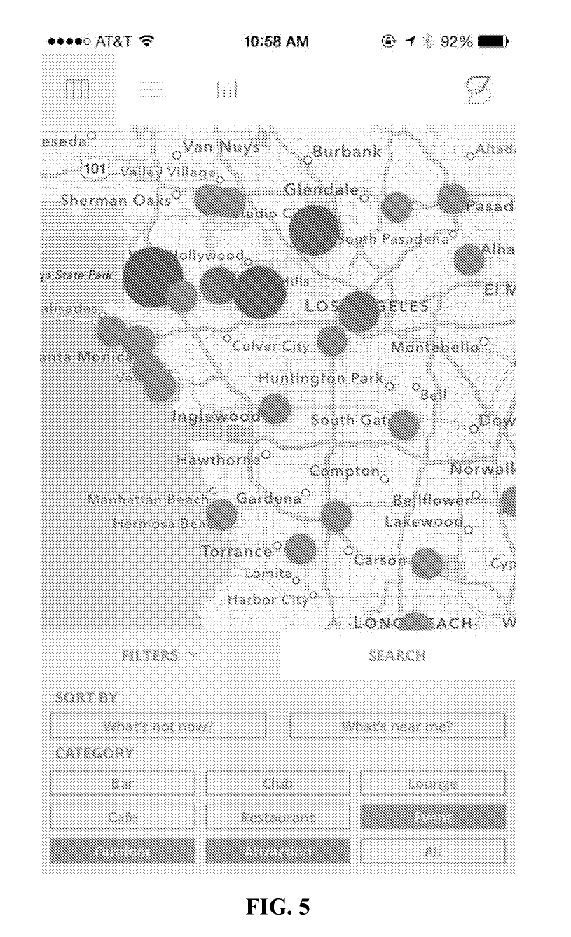

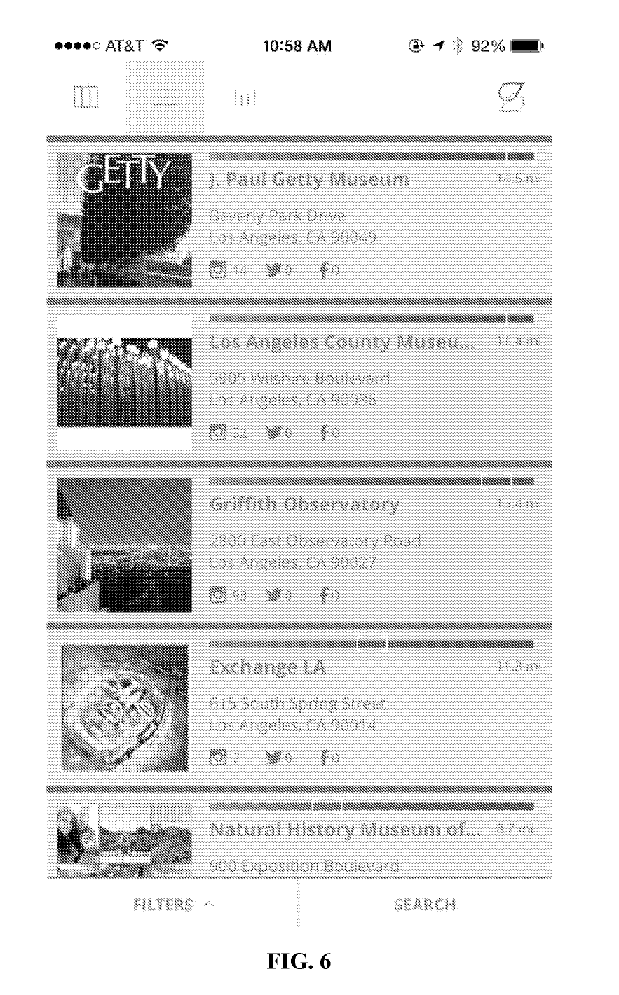

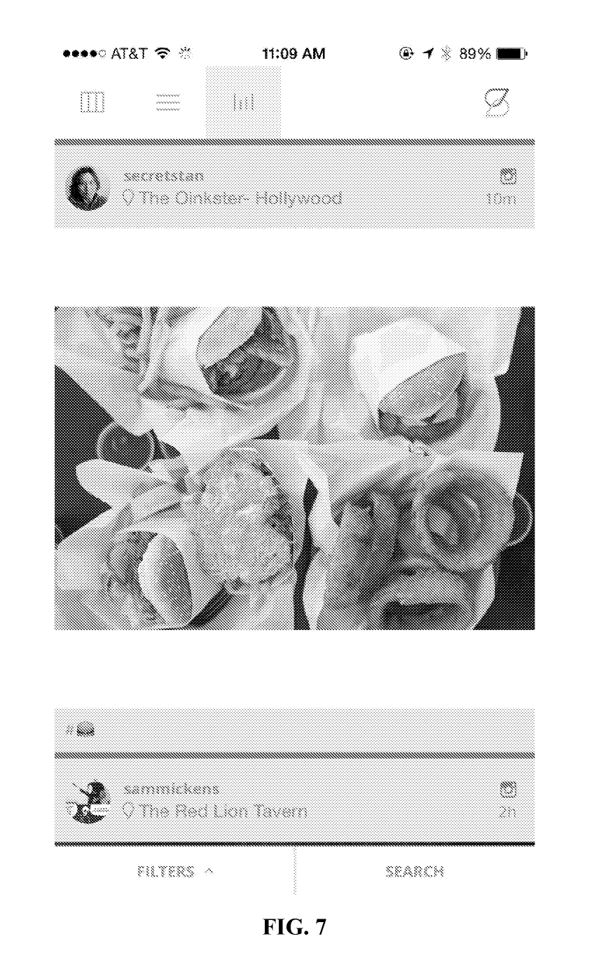

In step 106, the social activity analysis computing device 12 may provide a list of types of social activity interfaces that are available to the requesting one of the client computing devices 16(1)-16(n), although other approaches may be used, such as having either default or a previously stored preference for the types of interface. By way of example only, the types of social activity interfaces may include a map view interface, a list view interface, and/or a social content feed interface as illustrated by examples in FIGS. 5-7, although other types and/or numbers of interfaces may be available. In this particular example, the map view interface provides at least a first representation of the determined level of social activity at each of the stored venue locations within the first set distance of the identified location on a map. Additionally, in this particular example the list view interface provides a list of the stored venue locations within the first set distance of the identified location with at least a second representation of the determined level of social activity at each of the stored venue locations. Further, in this particular example the social content feed interface provides the social media content on the one or more social media server devices indexed in real time to each of the stored venue locations within the first set distance of the identified location in a scrolling format starting with the most recent entry of social media content for one of the stored venue locations. Additionally, this scrollable social media content may also include a geo tag associated with the corresponding one of the stored venue locations that was inserted by the social activity analysis computing device 12 to enable a user of the requesting one of the client computing devices 16(1)-16(n) to select and go to a venue interface (as described by in an example herein) for the selected one of the stored venue locations.

In step 108, the social activity analysis computing device 12 may receive the requested type of interface from the requesting one of the client computing devices and generate the requested social activity interface based on the determined level of social activity at each of the stored venue locations within the first set distance of the identified location. In this particular example, the social activity analysis computing device 12 may also adjust at least one of a display color or a display size associated with each of the stored venue locations based on the determined level of social activity at each of the stored venue locations. For example, the illustrated color at each of the stored venue locations in the map view interface or the list view interface may be red color indicating a high level of concentrated social activity above a stored threshold value in memory 22 and a blue color indicating a low level of concentrated social activity below another stored threshold value in memory 22. In another example, graphics associated with a stored venue location may be enlarged or reduced based on respectively higher or lower levels of determined social activity.

In step 110, the social activity analysis computing device 12 may provide the generated social activity interface to the requesting one of the client computing devices 16(1)-16(n), although the generated social activity interface may be managed in other manners, such as being distributed to one or more of the other client computing devices 16(1)-16(n) linked to the requesting one of the client computing devices 16(1)-16(n) by way of example only.

In step 112, the social activity analysis computing device 12 may determine when a request to generate a modified social activity interface based on the one or more filtering criteria has been received from the one of the client computing devices 16(1)-16(n). If in step 112 the social activity analysis computing device 12 determines a request to generate a modified social activity interface based on the one or more filtering criteria has not been received, then the No branch is taken to step 116. If in step 112 the social activity analysis computing device 12 determines a request to generate a modified social activity interface based on the one or more filtering criteria has been received, then the Yes branch is taken to step 114

In step 114, the social activity analysis computing device 12 may generate a modified social activity interface based on the one or more filtering criteria in the received a request from the one of the client computing devices 16(1)-16(n), although other approaches for adjusting the generated social activity interface may be used, such as based on a periodic real time update on the social media content associated with the stored venue locations. A variety of different types and/or numbers of filtering criteria may be used, such as a criteria that identifies one or more of a plurality of selected types of venue locations, for example types of restaurants, a criteria that would modify the set distance from the identified location, and/or a criteria of level of social activity by way of example only. The social activity analysis computing device 12 provides the generated modification of the social activity interface back to the requesting one of the client computing devices 16(1)-16(n).

In step 116, the social activity analysis computing device 12 may determine when a selection of one of the stored venue locations from the one of the client computing devices 16(1)-16(n) has been received, although a selection of one of the stored venue locations can be received in other manners. If in step 116, the social activity analysis computing device 12 determines a selection of one of the stored venue locations has been not been received, then the No branch is taken to step 120. If in step 116, the social activity analysis computing device 12 determines a selection of one of the stored venue locations has been received, then the Yes branch is taken to step 118.

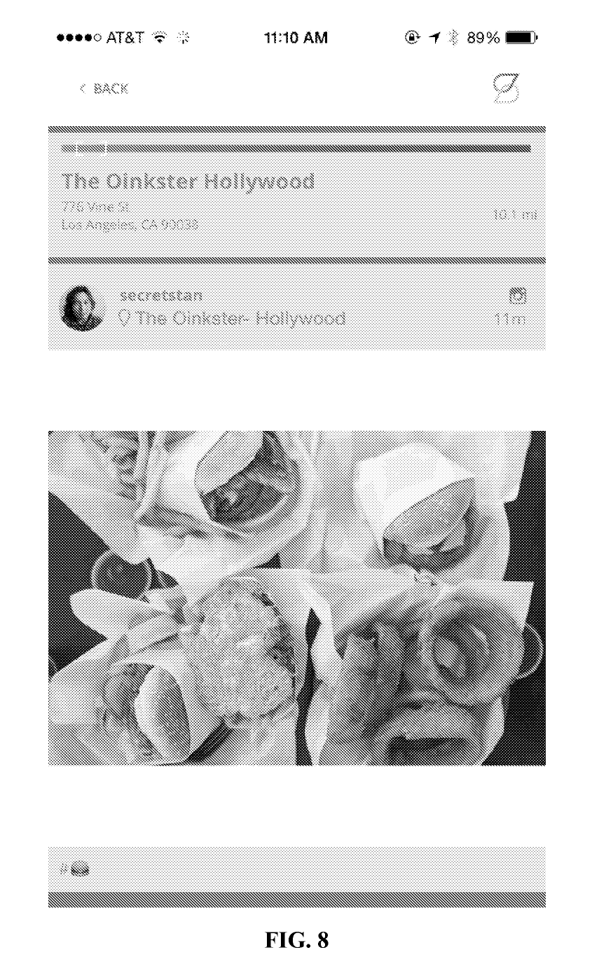

In step 118, the social activity analysis computing device 12 retrieve in real time the social media content on the one or more social media server devices 14(1)-14(n) indexed to the received selection of one of the stored venue locations. Next, the social activity analysis computing device 12 may generate and provide a venue interface to display the retrieved social media content indexed to the selected one of the stored venue locations to the requesting one of the client computing devices 16(1)-16(n) as illustrated by way of example in FIG. 8.

In step 120, the social activity analysis computing device 12 may determine whether interaction with the current version of the social activity interface has ended. If the social activity analysis computing device 12 determines interaction with the current version of the social activity has not ended, then the No branch is taken back to step 112. If the social activity analysis computing device 12 determines interaction with the current version of the social activity has ended, then the Yes branch is taken to step 122 where this example of the method ends.

As illustrated and described by way of the examples herein, this technology provides methods, non-transitory computer readable media, and devices that identify from social media content and in real time levels of concentrated social activity at stored venue locations within a set distance of an identified location. With this technology social hotspots at different stored venue locations within a set distance of an identified location or a region can be identified through a real time analysis of social media content from diverse social media sources and then provided to a client computing device in unique and informative formats. Additionally, this technology is able to generate interactive interfaces which enable client computing devices to obtain, interact, and/or filter in real time with the social media content in a region or associated with a selected stored venue location.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for identifying in real time levels of concentrated social activity at stored venue locations, the method comprising:
identifying, by a social activity analysis computing device, a location of a client computing device in response to a request for identification of concentrated social activity from the client computing device;
determining, by the social activity analysis computing device, a level of social activity at each of the stored venue locations within a first set distance of the identified location based on social media content on one or more social media server devices indexed in real time to each of the stored venue locations within a first set distance of the identified location;
generating, by the social activity analysis computing device, at least one social activity interface based on the determined level of social activity at each of the stored venue locations within the first set distance of the identified location; and
providing, by the social activity analysis computing device, the generated social activity interface to the requesting client computing device.

2. The method of claim 1 wherein the determining the level of social activity at each of the stored venue locations within the first set distance of the identified location further comprises applying, by the social activity analysis computing device, a weighting factor to the indexed social media content identified to originate from within first stored coordinates for each of the stored venue locations.

3. The method of claim 1 wherein the determining the level of social activity at each of the stored venue locations within the first set distance of the identified location further comprises web crawling, by the social activity analysis computing device, to index the social media content on the one or more social media server devices to each of the stored venue locations within the first set distance of the identified location based on one or more parameters.

4. The method of claim 3 further comprising receiving, by the social activity analysis computing device, an input of the one or more parameters associated with one or more of the stored venue locations.

5. The method of claim 3 wherein the one or more parameters comprises at least one of one or more stored hash tags or stored handles associated with one or more of the stored venue locations.

6. The method of claim 1 wherein the generating the social activity interface further comprises generating, by the social activity analysis computing device, in response to a received interface request from the requesting client computing device at least one of:
a map view interface of at least a first representation of the determined level of social activity at each of the stored venue locations within the first set distance of the identified location on a map;
a list view interface of a list of the stored venue locations within the first set distance of the identified location with at least a second representation of the determined level of social activity at each of the stored venue locations; or
a social content feed interface of the social media content on the one or more social media server devices indexed in real time to each of the stored venue locations within the first set distance of the identified location.

7. The method of claim 6 further comprises:
obtaining, by the social activity analysis computing device, a selection of one of the stored venue locations provided via one of the generated map view interface, the generated list view interface, or the social content feed interface;
retrieving, by the social activity analysis computing device, in real time the social media content on the one or more social media server devices associated with the selected one of the stored venue locations; and
generating, by the social activity analysis computing device, a venue interface to display the retrieved social media content associated with the selected one of the stored venue locations.

8. The method as set forth in claim 6 further comprising adjusting, by the social activity analysis computing device, at least one of a display color or a display size associated with each of the stored venue locations based on the determined level of social activity at each of the stored venue locations.

9. The method as set forth in claim 1 further comprising:
filtering, by the social activity analysis computing device, the social activity interface based on a received selection of at least by one of a plurality of types of stored venue locations and a modified first set distance from the identified location from the requesting client computing device; and
generating, by the social activity analysis computing device, a modified social activity interface based on the filtering.

10. A social activity analysis computing device, comprising:
at least one of configurable hardware logic configured to be capable of implementing or a memory coupled to the processor which is configured to be capable of executing programmed instructions stored in the memory to and that comprise:
identify a location of a client computing device in response to a request for identification of concentrated social activity from the client computing device;
determine a level of social activity at each of the stored venue locations within a first set distance of the identified location based on social media content on one or more social media server devices indexed in real time to each of the stored venue locations within a first set distance of the identified location;
generate at least one social activity interface based on the determined level of social activity at each of the stored venue locations within the first set distance of the identified location; and
provide the generated social activity interface to the requesting client computing device.

11. The device of claim 10 wherein the at least one of configurable hardware logic configured to be capable of implementing or the memory coupled to the processor which is configured to be capable of executing programmed instructions stored in the memory to determine the level of social activity at each of the stored venue locations within the first set distance of the identified location and that further comprises:
apply a weighting factor to the indexed social media content identified to originate from within first stored coordinates for each of the stored venue locations.

12. The device of claim 10 wherein the at least one of configurable hardware logic configured to be capable of implementing or the memory coupled to the processor which is configured to be capable of executing programmed instructions stored in the memory to determine the level of social activity at each of the stored venue locations within the first set distance of the identified location and that further comprises:
web crawl to index the social media content on the one or more social media server devices to each of the stored venue locations within the first set distance of the identified location based on one or more parameters.

13. The device of claim 12 wherein the at least one of configurable hardware logic configured to be capable of implementing or the memory coupled to the processor which is configured to be capable of executing programmed instructions stored in the memory to and that further comprises receive an input of the one or more parameters associated with one or more of the stored venue locations.

14. The device of claim 12 wherein the one or more parameters comprises at least one of one or more stored hash tags or stored handles associated with one or more of the stored venue locations.

15. The device of claim 10 wherein the at least one of configurable hardware logic configured to be capable of implementing or the memory coupled to the processor which is configured to be capable of executing programmed instructions stored in the memory to generate the social activity interface and that further comprises:
generate in response to a received interface request from the requesting client computing device at least one of:
a map view interface of at least a first representation of the determined level of social activity at each of the stored venue locations within the first set distance of the identified location on a map;
a list view interface of a list of the stored venue locations within the first set distance of the identified location with at least a second representation of the determined level of social activity at each of the stored venue locations; or
a social content feed interface of the social media content on the one or more social media server devices indexed in real time to each of the stored venue locations within the first set distance of the identified location.

16. The device of claim 15 wherein the at least one of configurable hardware logic configured to be capable of implementing or the memory coupled to the processor which is configured to be capable of executing programmed instructions stored in the memory to and that further comprises:
obtain a selection of one of the stored venue locations provided via one of the generated map view interface, the generated list view interface, or the social content feed interface;
retrieve in real time the social media content on the one or more social media server devices associated with the selected one of the stored venue locations; and
generate a venue interface to display the retrieved social media content associated with the selected one of the stored venue locations.

17. The device as set forth in claim 15 wherein the at least one of configurable hardware logic configured to be capable of implementing or the memory coupled to the processor which is configured to be capable of executing programmed instructions stored in the memory to and that further comprises adjust at least one of a display color or a display size associated with each of the stored venue locations based on the determined level of social activity at each of the stored venue locations.

18. The device as set forth in claim 10 wherein the at least one of configurable hardware logic configured to be capable of implementing or the memory coupled to the processor which is configured to be capable of executing programmed instructions stored in the memory to and that further comprises:
filter the social activity interface based on a received selection of at least by one of a plurality of types of stored venue locations and a modified first set distance from the identified location from the requesting client computing device; and
generate a modified social activity interface based on the filtering.

19. A non-transitory computer readable medium having stored thereon instructions for identifying in real time levels of concentrated social activity at stored venue locations comprising machine executable code which when executed by a processor, causes the processor to perform steps comprising:
identifying a location of a client computing device in response to a request for identification of concentrated social activity from the client computing device;
determining a level of social activity at each of the stored venue locations within a first set distance of the identified location based on social media content on one or more social media server devices indexed in real time to each of the stored venue locations within a first set distance of the identified location;
generating at least one social activity interface based on the determined level of social activity at each of the stored venue locations within the first set distance of the identified location; and
providing the generated social activity interface to the requesting client computing device.

20. The medium of claim 19 wherein the determining the level of social activity at each of the stored venue locations within the first set distance of the identified location further comprises applying a weighting factor to the indexed social media content identified to originate from within first stored coordinates for each of the stored venue locations on.

21. The medium of claim 19 wherein the determining the level of social activity at each of the stored venue locations within the first set distance of the identified location further comprises web crawling to index the social media content on the one or more social media server devices to each of the stored venue locations within the first set distance of the identified location based on one or more parameters.

22. The medium of claim 21 further comprising receiving an input of the one or more parameters associated with one or more of the stored venue locations.

23. The medium of claim 21 wherein the one or more parameters comprises at least one of one or more stored hash tags or stored handles associated with one or more of the stored venue locations.

24. The medium of claim 19 wherein the generating the social activity interface further comprises generating in response to a received interface request from the requesting client computing device at least one of:
a map view interface of at least a first representation of the determined level of social activity at each of the stored venue locations within the first set distance of the identified location on a map;
a list view interface of a list of the stored venue locations within the first set distance of the identified location with at least a second representation of the determined level of social activity at each of the stored venue locations; or
a social content feed interface of the social media content on the one or more social media server devices indexed in real time to each of the stored venue locations within the first set distance of the identified location.

25. The medium of claim 24 further comprises:
obtaining a selection of one of the stored venue locations provided via one of the generated map view interface, the generated list view interface, or the social content feed interface;
retrieving in real time the social media content on the one or more social media server devices associated with the selected one of the stored venue locations; and
generating a venue interface to display the retrieved social media content associated with the selected one of the stored venue locations.

26. The medium as set forth in claim 24 further comprising adjusting at least one of a display color or a display size associated with each of the stored venue locations based on the determined level of social activity at each of the stored venue locations.

27. The medium as set forth in claim 19 further comprising:
filtering the social activity interface based on a received selection of at least by one of a plurality of types of stored venue locations and a modified first set distance from the identified location from the requesting client computing device; and
generating a modified social activity interface based on the filtering.
